(19) United States
(12) Patent Application Publication
(10) Pub. No.: US 2016/0215224 A1
(43) Pub. Date: Jul. 28, 2016

(54) Chemical Substance Production System and Chemical Substance Production Method

(71) Applicant: HITACHI, LTD., Tokyo (JP)

(72) Inventors: Hiroko TADA, Tokyo (JP); Nami SUGITA, Tokyo (JP); Norihito KUNO, Tokyo (JP)

(21) Appl. No.: 14/914,199

(22) PCT Filed: Aug. 28, 2013
(86) PCT No.: PCT/JP2013/072937

§ 371 Date: Feb. 24, 2016

(51) Int. Cl. C10L 1/02; C11C 3/00; C11B 1/10; B01J 19/24; B01J 19/00

(52) U.S. Cl. CPC C10L 1/026; B01J 19/2475; B01J 19/0006; C11B 1/10; C11C 3/003; B01J 2219/24; C10L 2200/0469; C10L 2290/548; C10L 2290/60; C10L 2290/58

(57) ABSTRACT

As one aspect of the present invention, a chemical substance production system includes a first liquid reaction system that generates a first chemical substance, a second liquid reaction system that generates a second chemical substance, and a first membrane that is provided between the first liquid reaction system and the second liquid reaction system, wherein the second liquid reaction system causes a chemical reaction of the first chemical substance transferred from the first liquid reaction system to the second liquid reaction system through the first membrane, thereby generating the second chemical substance. According to this, a fuel production system that efficiently removes contaminants occurring in an extraction step when producing fuel derived from an alga or the like is provided.

### TECHNICAL FIELD

The present invention relates to a chemical substance production system and a chemical substance production method, and particularly relates to a system and a method for producing a chemical substance to be used as fuel from an alga.

### BACKGROUND ART

As measures for global warming or oil depletion problems, the production of biofuel (hereinafter referred to as “BDF”) derived from a microalga has attracted attention. A process for producing BDF (registered trademark) from a microalga is broadly divided into a step of extracting oils and fats (hereinafter referred to as “triglycerides”) from a microalga and a step of converting the extracted triglycerides to fuel. In the triglyceride extraction step, extraction using any of various organic solvents or extraction utilizing a physical energy such as an ultrasonic wave is performed. The triglyceride conversion step is performed such that the triglycerides and methanol are mixed at a high temperature to effect methyl esterification of the triglycerides. In order to produce fuel, it is necessary to simplify these steps and enhance the efficiency, and recently, an attempt has been made for performing these steps in one step.

As a method for performing the triglyceride extraction step and the fuel conversion step in one step, in NPL 1, the extraction step and the fuel conversion step are performed in one step by irradiating an alga with a microwave in the presence of methanol and strontium oxide.

### CITATION LIST

### Non Patent Literature

NPL 1: Koberg M, Cohen M, Ben-Amotz A, Gedanken A.; Bio-diesel production directly from the microalgae biomass of Nannochloropsis by microwave and ultrasound radiation. Bioresour Technol. 102(5), 4265-4269, 2011

### SUMMARY OF INVENTION

### Technical Problem

The above-mentioned NPL 1 discloses that the efficiency of triglyceride extraction and fuel conversion is enhanced by performing the extraction step and the fuel conversion step using a microwave in one step, but does not describe the purity of the fuel produced. In the case where the purity of fuel is low, for example, when the fuel is used in an engine of a vehicle or the like, there may occur problems such that a filter in the engine clogs to cause a breakdown in the engine.

Further, in the presence of contaminants such as an algal residue, the efficiency of fuel conversion may be deteriorated due to the effect of the contaminants, and it is considered that in the case where the efficiency of fuel conversion is deteriorated, the fuel yield is decreased, or the unreacted triglycerides remain in the fuel. The triglycerides remaining in the fuel have a lower melting point or lower fluidity than the fuel, and therefore, it is considered that when such fuel is used in an engine of a vehicle or the like, clogging is liable to occur in a pipe so that a decrease in the performance of the engine or a breakdown in the engine may be caused.

In the light of the above circumstances, an object of the present invention is to efficiently remove contaminants occurring in the step of extracting a chemical substance from a raw material and to efficiently convert the chemical substance extracted from the raw material to fuel.

### Solution to Problem

As one aspect of the present invention for solving at least one problem of the above-mentioned problems, a chemical substance production system includes a first liquid reaction system that generates a first chemical substance, a second liquid reaction system that generates a second chemical substance, and a first membrane that is provided between the first liquid reaction system and the second liquid reaction system, wherein the second liquid reaction system causes a chemical reaction of the first chemical substance transferred from the first liquid reaction system to the second liquid reaction system through the first membrane, thereby generating the second chemical substance.

### Advantageous Effects of Invention

According to the present invention, contaminants occurring in the step of extracting a chemical substance from a raw material can be efficiently removed, and the chemical substance extracted from the raw material can be efficiently converted to fuel. Problems, configurations, and advantageous effects other than those described above will become apparent from the following description of embodiments.

### BRIEF DESCRIPTION OF DRAWINGS

FIG. 1 is a view showing a schematic configuration diagram of a fuel production system of the present invention.

FIG. 2 is a view showing a cross-sectional view of a microwave irradiation section included in the fuel production system of the present invention.

FIG. 3 is a view showing a block configuration diagram of a control system included in the fuel production system of the present invention.

FIG. 4 is a view showing a control flow in the control system of the fuel production system of the present invention.

### DESCRIPTION OF EMBODIMENTS

Hereinafter, preferred embodiments of the present invention will be illustratively described in detail in the following embodiment with reference to the drawings. However, the dimensions, materials, shapes, other relative positions, and the like of the constituent components described in this embodiment are not intended to limit the scope of this invention and are merely explanatory examples unless otherwise specifically described.

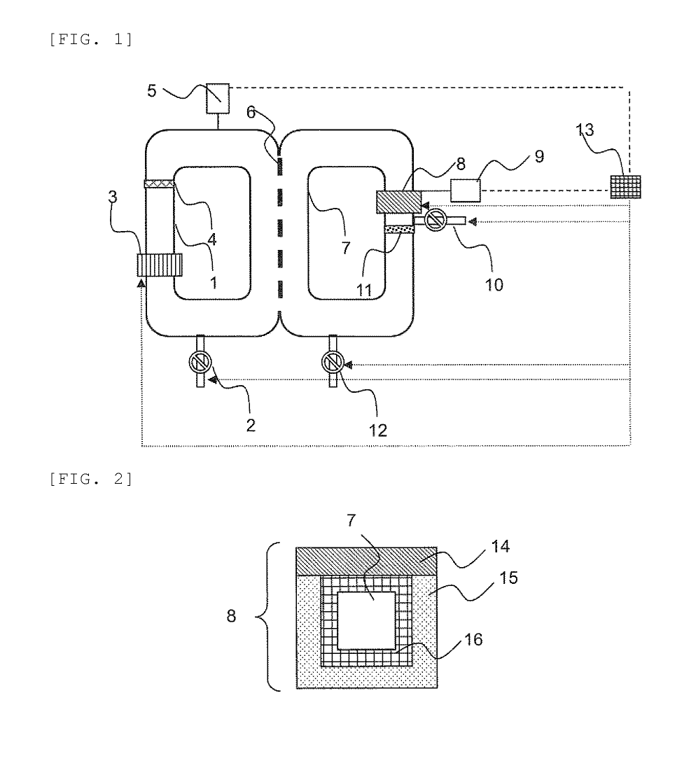

First, the configuration of a fuel production system in this embodiment will be described with reference to FIG. 1. Here, the fuel production system of this embodiment is suitable for producing fuel from an alga, and therefore, a description will be made by illustrating an embodiment using an alga as a raw material, however, the fuel production system shown in FIG. 1 can also use a plant, a wood material, a wood waste, a food, a food waste, or the like as a raw material other than an alga.

Examples of the alga to be used as a raw material include algae of the genus Botryococcus, the genus Nannochloropsis, the genus Neochloris, the genus Phaeodactylum, the genus Dunaliella, the genus Aurantiochytrium, the genus Chlorella, the genus Pseudochoricystis, the genus Fistulifera, and the like.

In the fuel production system according to this embodiment, as shown in FIG. 1, a first reaction system 1 which is a liquid reaction system that extracts triglycerides from a raw material, and a second reaction system 7 which is a liquid reaction system that converts the triglycerides to fuel are provided adjacent to each other through a membrane 6.

Further, the system is controlled based on a control signal from a control device 13. That is, by the control device 13, the mechanisms of an algal inlet valve 2, a homogenization section 3, a triglyceride concentration meter 5, a microwave irradiation section 8, a triglyceride/BDF concentration meter 9, a BDF outlet valve 10, and a solvent inlet valve 12, which will be described later, and the flow rate, flow amount, and the like of the liquid in the first reaction system 1 and the second reaction system 7 are controlled.

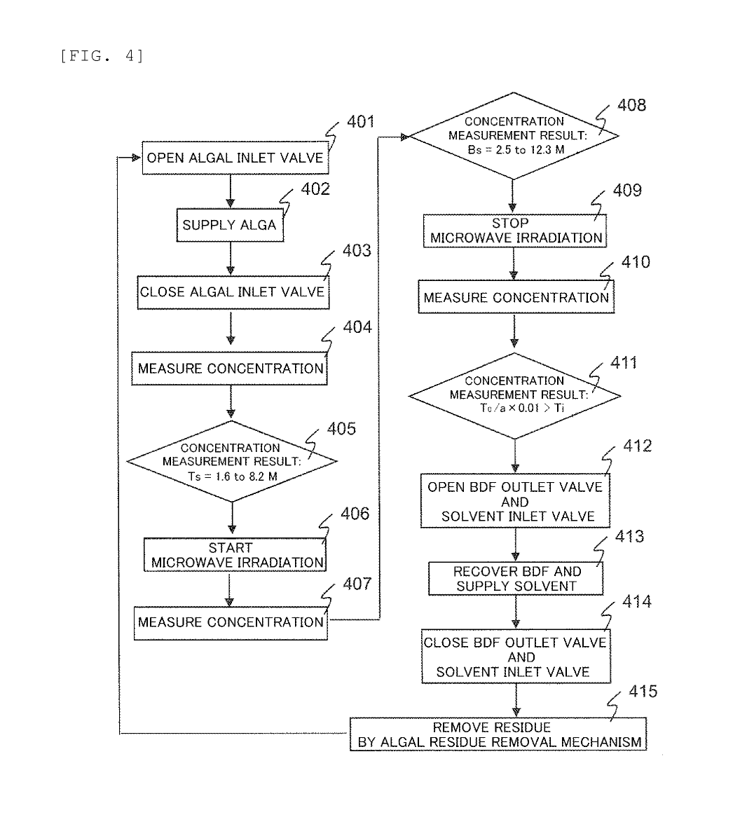

As shown in FIG. 3, the control device 13 is constituted by a display 301, an input section 302 to be used for input when the system is controlled by a system administrator or the like, and a control unit 303. Further, the control unit 303 is constituted by a microwave irradiation control section 304 that controls irradiation with a microwave, a valve control section 305 that controls the opening/closing of each valve, a homogenization control section 306 that controls homogenization of a raw material, a concentration measurement control section 307 that controls the measurement of the concentration of triglycerides or BDF, and a flow rate/flow amount control section 308 that controls the flow rate/flow amount of the liquid in the liquid reaction system.

Each of these control sections included in the control unit 303 can be realized with software by interpreting and executing a program stored in a memory for realizing the respective functions by a processor. Further, the respective control sections may be realized with hardware by designing some or all of the control sections in, for example, an integrated circuit or the like. The information of a program, a file, a database, or the like for realizing the function of each control section can also be put in, for example, a recording device such as a memory, a hard disk, or an SSD (Solid State Drive), or a recording medium such as an IC card, an SD card, or a DVD.

The first reaction system 1 includes an algal inlet valve 2 for supplying an alga, a homogenization section 3 that accelerates the homogenization of the alga when extracting triglycerides from the alga, a residue removal mechanism 4 for removing an algal residue after homogenization, and a triglyceride concentration meter 5 for measuring the concentration of the triglycerides in the first reaction system. In the inside of the flow path of the first reaction system 1, a liquid containing methanol for dissolving the triglycerides circulates and flows in the flow path by a circulation pump or the like. The content of methanol is desirably 70% or more but is not necessarily limited thereto.

A homogenization method to be used in the homogenization section 3 is not particularly limited, however, examples thereof include an ultrasonic irradiation method, a microwave heating method, an infrared heating method, and a homogenization method using a French press, a homogenizer, or the like. Further, a method for removing an algal residue used in the residue removal mechanism 4 is not particularly limited, however, for example, the residue may be removed by filtering a solution containing the residue using a filter, or by discharging the residue precipitated on a bottom portion of the reaction system from a valve or the like disposed on the bottom portion. Further, a concentration measurement method to be used in the triglyceride concentration meter 5 is not particularly limited, however, examples thereof include liquid chromatography, gas chromatography, and gas chromatography-mass spectrometry.

The membrane 6 is provided as a boundary between the first reaction system 1 and the second reaction system 2. The membrane 6 is desirably a membrane having resistance to methanol and has a heat resistant temperature of 60° C. or higher as described below, but is not necessarily limited thereto. Examples of the material of the membrane include Anopore, cellulose acetate, polycarbonate, polyester, glass fibers, nylon, polypropylene, depth polypropylene, polysulfone, polyethersulfone, Teflon (registered trademark), polyvinylidene fluoride, and cellulose. The pore diameter of the membrane is not particularly limited, but is desirably, for example, 1.3 nm or more.

The membrane 6 allows separation based on the size of a substance by dialysis. The molecular weight of the triglycerides to be separated in this embodiment is from about 700 to 1000 g/mol. The molecular weight cutoff of the membrane 6 to be used in the present invention is equal to or more than the molecular weight of the triglycerides, and therefore, the triglycerides permeate the membrane from the first reaction system 1 to the second reaction system 7, and a substance having a molecular weight equal to or more than the molecular weight cutoff of the membrane 6 remains in the first reaction system 1 as a contaminant. According to this, the triglycerides extracted from the alga are separated from contaminants. As a dialysis condition to be used in this embodiment, diffusion dialysis or pressure dialysis can be used.

The second reaction system 7 includes a microwave irradiation section 8 as a chemical reaction section that converts the triglycerides to BDF, a triglyceride/BDF concentration meter 9 for measuring the concentrations of the triglycerides and BDF in the second reaction system, a BDF outlet valve 10 for recovering BDF, a hydrophilic membrane 11 for damming up BDF and preventing BDF from going back to the first reaction system, and a solvent inlet valve 12 for supplying a solvent. In the inside of the flow path of the second reaction system 7, a liquid containing methanol to be used in a methyl esterification reaction circulates and flows by a circulation pump or the like. The content of methanol is desirably 70% or more but is not necessarily limited thereto.

The microwave irradiation condition in the microwave irradiation section 8 is not particularly limited, but is desirably such that the temperature around the microwave irradiation section 8 is 60° C. or higher and the boiling point of methanol (64.7° C.) or lower. Examples of the microwave irradiation method include continuous irradiation in which a microwave is irradiated continuously, and irradiation with a pulse wave in which on/off irradiation in a short time is repeated.

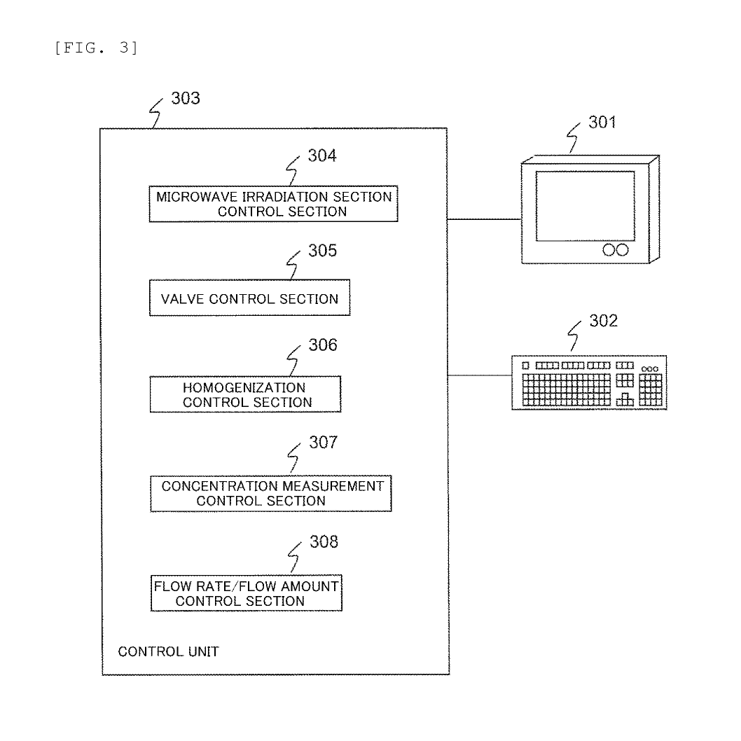

A configuration example of the microwave irradiation section 8 will be described using the cross-sectional view in FIG. 2. The microwave irradiation section 8 is constituted by a catalyst fixing section 16 in contact with an inner wall of the second reaction system 7, a magnetron 14 in contact with an outer wall, and a shielding section 15. A catalyst to be used in the catalyst fixing section 16 is not particularly limited, however, examples thereof include an alkali catalyst, an acid catalyst, and a solid catalyst. Examples of the alkali catalyst include sodium hydroxide and potassium hydroxide. Examples of the acid catalyst include sulfuric acid, hydrochloric acid, and boron trifluoride. Examples of the solid catalyst include metal oxides such as strontium oxide, barium oxide, calcium oxide, and magnesium oxide, metal hydroxides such as strontium hydroxide, barium hydroxide, calcium hydroxide, and magnesium hydroxide, metal sulfates such as zirconia sulfate, an ion exchange resin, and zeolite. The solid catalyst can prevent the catalyst from flowing out into the second reaction system, and therefore is desirable as the catalyst to be used in the fuel production system of this embodiment.

As shown in FIG. 1, the second reaction system 7 includes the hydrophilic membrane 11 on the downstream side of the microwave irradiation section 8, particularly between the microwave irradiation section 8 and the membrane 6. By the hydrophilic membrane 11, BDF is dammed up and does not circulate in the second reaction system 7, thereby preventing BDF from going back to the first reaction system 1. Further, by the effect of the hydrophilic membrane 11, in the first reaction system 1 and the second reaction system 7, the triglyceride concentration gradient is maintained, and the triglyceride concentration does not reach equilibrium, and therefore, the triglycerides can be dialyzed continuously. A material of the hydrophilic membrane 11 is desirably a material having resistance to methanol as shown below, but is not necessarily limited thereto. Examples thereof include a zeolite membrane, Anopore, cellulose acetate, glass fibers, nylon, and polyethersulfone.

Incidentally, a concentration measurement method to be used in the triglyceride/BDF concentration meter 9 is not particularly limited, however, examples thereof include liquid chromatography, gas chromatography, and gas chromatography-mass spectrometry.

Further, although the details are omitted in FIG. 1, in the vicinity of each valve of the algal inlet valve 2, the BDF outlet valve 10, and the solvent inlet valve 12, a flowmeter that measures the flow amount of the liquid in the respective reaction systems is provided. In the first reaction system and the second reaction system, by the control device 13, the liquid amount and the liquid flow are controlled based on the measured flow amount. A direction of the liquid flow in the first reaction system and the second reaction system is not particularly limited, however, the liquid desirably circulates and flows in the flow path in the opposite direction through the membrane. The concentrations of the triglycerides and BDF are high on the upstream side in the liquid flow direction, and therefore, by setting the liquid flow direction to the opposite direction through the membrane, a concentration gradient difference through the membrane is increased, and thus, the efficiency of dialysis of the triglycerides can be enhanced.

Hereinafter, an operation flow in the first reaction system 1 and the second reaction system 7 based on the control by the control device 13 will be described using FIG. 4. First, the algal inlet valve 2 is opened (401), and an alga cultured in a facility in a different system is supplied to the first reaction system 1 (402). The algal inlet valve 2 is closed (403), and triglycerides are extracted from the alga in the first reaction system 1. Thereafter, concentration measurement is performed (404), and when the concentration Ts of the triglycerides dialyzed from the first reaction system 1 into the second reaction system 7 reached 1.6 to 8.2 M (405), a microwave is irradiated from the microwave irradiation section 8 (406). By irradiating the triglycerides with the microwave in the presence of a catalyst and methanol, the following methyl esterification reaction occurs.

Triglyceride+3 methanol→3 BDF+glycerin

By the methyl esterification reaction, 3 BDF molecules are generated from one triglyceride molecule. Concentration measurement is performed again (407), and when the concentration Bs of BDF in the second reaction system 7 reached 2.5 to 12.3 M (408), the microwave irradiation in the microwave irradiation section 8 is stopped (409).

Concentration measurement is performed again (410), and when the concentration Ti of the triglycerides in the first reaction system 1 reached T₀/a×0.01 (T₀ represents the total amount of triglycerides contained in the alga, and a represents the amount of methanol in the first reaction system 1) (411), the BDF outlet valve 10 and the solvent inlet valve 12 are opened (412), whereby BDF dammed up is recovered, and also a solvent is supplied from the solvent inlet valve 12 (413). At this time, the amount of the liquid recovered from the BDF outlet valve 10 is the total amount of the amount of the solvent flowing in from the solvent inlet valve 12 and the amount of the liquid flowing in from the algal inlet valve 2.

The recovered BDF is separated from methanol, the unreacted triglycerides, and the like by undergoing a distillation step, and thus, can be used as fuel. After closing the BDF outlet valve 10 and the solvent inlet valve 12 (414), the algal residue retained in the algal residue removal mechanism 4 is removed (415), and a new alga is supplied from the algal inlet valve 2 (401, 402), whereby the fuel production system of the present invention is continuously operated.

As described above, by applying the fuel production system in this embodiment, a fuel production system in which when BDF derived from an alga is produced, contaminants occurring in the extraction step can be efficiently removed, and the subsequent fuel conversion step is continuously performed can be realized.

Further, in the above-mentioned system, by mounting the residue removal mechanism 4 on the upstream side of the membrane for removing the contaminants, the clogging of the membrane for removing the contaminants can be prevented.

Further, by disposing the hydrophilic membrane 11 for damming up and recovering BDF on the downstream side of the chemical reaction section, BDF can be easily recovered.

### REFERENCE SINGS LIST

1: first reaction system
2: algal inlet valve
3: homogenization section
4: algal residue removal mechanism
5: triglyceride concentration meter
6: membrane
7: second reaction system
8: microwave irradiation section
9: triglyceride/BDF concentration meter
10: BDF outlet valve
11: hydrophilic membrane
12: solvent inlet valve
13: control device
14: magnetron
15: shielding section
16: catalyst fixing section

1. A chemical substance production system, comprising:
a first liquid reaction system that generates a first chemical substance;
a second liquid reaction system that generates a second chemical substance; and
a first membrane that is provided between the first liquid reaction system and the second liquid reaction system, wherein
the second liquid reaction system causes a chemical reaction of the first chemical substance transferred from the first liquid reaction system to the second liquid reaction system through the first membrane, thereby generating the second chemical substance.

2. The chemical substance production system according to claim 1, wherein the first liquid reaction system extracts the first chemical substance from a raw material.

3. The chemical substance production system according to claim 2, wherein the first membrane allows the raw material and a residue of the raw material after extracting the first chemical substance to remain in the first liquid reaction system, and allows the first chemical substance to pass therethrough to the second liquid reaction system.

4. The chemical substance production system according to claim 2, wherein the first liquid reaction system includes a residue removal section that removes a residue of the raw material after extracting the first chemical substance.

5. The chemical substance production system according to claim 2, wherein the first liquid reaction system extracts the first chemical substance from an alga which is the raw material.

6. The chemical substance production system according to claim 1, wherein the second liquid reaction system includes:
a chemical reaction section that converts the first chemical substance to the second chemical substance;
a concentration measurement section that measures at least either of the concentration of the first chemical substance and the concentration of the second chemical substance in the second liquid reaction system; and
a control unit that controls a reaction in the chemical reaction section based on the concentration value measured by the concentration measurement section.

7. The chemical substance production system according to claim 1, wherein
the first liquid reaction system is constituted by a first liquid flow path through which a liquid flows,
the second liquid reaction system is constituted by a second liquid flow path through which a liquid flows, and
the first membrane allows the first chemical substance in a liquid flowing through the first liquid flow path to pass therethrough into a liquid flowing through the second liquid flow path.

8. The chemical substance production system according to claim 7, wherein the second liquid flow path includes a second membrane that does not allow the second chemical substance to pass therethrough, and when a liquid flowing through the second liquid flow path passes through the second membrane, the second substance is retained on the upstream side of the second membrane.

9. The chemical substance production system according to claim 8, wherein
the second liquid reaction system includes a chemical reaction section that converts the first chemical substance to the second chemical substance, and
the second membrane is provided between the chemical reaction section and the first membrane.

10. The chemical substance production system according to claim 7, wherein the first liquid flow path and the second liquid flow path are constituted by a liquid circulation flow path through which a liquid circulates in the flow path.

11. A chemical substance production method, comprising:
supplying a raw material to a first reaction system;
generating a first chemical substance from the raw material in a first liquid reaction system; and
generating a second chemical substance in a second reaction system connected to the first reaction system through a membrane by causing a chemical reaction of the first chemical substance transferred from the first liquid reaction system to the second liquid reaction system through the first membrane.
